(19) United States
(12) Patent Application Publication
(10) Pub. No.: US 2026/0077298 A1
(43) Pub. Date: Mar. 19, 2026

(54) RNG GAS PROCESSING SKID AND ARRANGEMENTS INCLUDING SAME

(71) Applicant: MONTAUK ENERGY HOLDINGS, LLC, Pittsburgh, PA (US)

(72) Inventor: Cory Rey Sprouts, Darlington, PA (US)

(73) Assignee: MONTAUK ENERGY HOLDINGS, LLC, Pittsburgh, PA (US)

(21) Appl. No.: 19/333,922

(22) Filed: Sep. 19, 2025

Related U.S. Application Data
(60) Provisional application No. 63/696,502, filed on Sep. 19, 2024.

(51) Int. Cl. B01D 53/22; C10L 3/10

(52) U.S. Cl. CPC B01D 53/227; C10L 3/101; B01D 2258/05; B01D 2259/455

(57) ABSTRACT

A portable skid arrangement for processing renewable natural gas includes a frame and a plurality of gas separation membranes selectively coupled to the frame. Each gas separation membrane includes: an inlet structured to be in communication with, and to receive unprocessed gas from, a supply line; a flare outlet structured to be in communication with, and to disperse unwanted filtered gas separated from the unprocessed gas to a flare line; and a primary outlet structured to be in communication with, and to disperse remaining gas after the filtered gas has been separated from the unprocessed gas to an outlet line.

### CROSS REFERENCE TO RELATED APPLICATIONS

This application claims priority to U.S. Provisional Patent Application Ser. No. 63/696,502, filed on Sep. 19, 2024, titled “RNG GAS PROCESSING SKID AND ARRANGEMENTS INCLUDING SAME” the disclosure of which is incorporated herein by reference.

### FIELD

The disclosed concept relates generally to arrangements for processing renewable natural gas (RNG), and more particularly to portable skid arrangements for use in processing RNG. The disclosed concept further relates to systems for processing RNG that include one or more of such portable skid arrangements.

### BACKGROUND

Renewable natural gas (RNG) is a pipeline-quality gas that is interchangeable with conventional natural gas and thus can be used in natural gas vehicles. RNG is essentially biogas (the gaseous product of the decomposition of organic matter) that has been processed to purity standards. Like conventional natural gas, RNG can be used as a transportation fuel in the form of compressed natural gas (CNG) or liquefied natural gas (LNG).

Biomethane, which is another term for this purified pipeline-quality fuel, refers to biogas that has also been cleaned and conditioned to remove or reduce non-methane elements. Biogas is produced from various biomass sources through a biochemical process, such as anaerobic digestion, or through thermochemical means, such as gasification. With minor cleanup, biogas can be used to generate electricity and heat and is used as a replacement for traditional natural gas to generate combined electricity and heating for power plants (i.e., not in vehicle applications).

To fuel vehicles, biogas must be processed to a higher purity standard. This process is called conditioning or upgrading, and involves the removal of water, carbon dioxide, hydrogen sulfide, and other trace elements. The resulting RNG, or biomethane, has a higher content of methane than raw biogas, which makes it comparable to conventional natural gas and thus a suitable energy source in applications that require pipeline-quality gas, such as vehicle applications.

Existing processing arrangements for processing renewable natural gas (RNG) are large in size and thus require special equipment to move, require long lead times to build, and are generally fixed as to the volume of gas they can process. Embodiments of the disclosed concept address such shortcomings, among others, of existing arrangements.

### SUMMARY

As one aspect of the disclosed concept, a portable skid arrangement for processing renewable natural gas is provided. The skid arrangement comprises a frame; a plurality of gas separation membranes selectively coupled to the frame, each gas separation membrane including: an inlet structured to be in communication with, and to receive unprocessed gas from, a supply line; a flare outlet structured to be in communication with, and to disperse unwanted filtered gas separated from the unprocessed gas to a flare line; and a primary outlet structured to be in communication with, and to disperse remaining gas after the filtered gas has been separated from the unprocessed gas to an outlet line.

The frame may have a height that is equal to or greater than the greater of a width or a length of the frame. The frame may have a length of ten feet or less and a width of six feet or less. The frame may have a length of at least six feet. The frame may have a width of at least four feet. The frame may have a height of twelve feet or less. The frame may have a height of at least eight feet. The arrangement may have a total weight of less than 12,000 pounds. The arrangement may have a total weight of less than 6,000 pounds.

Each gas separation membrane may be disposed horizontally with the inlet and the primary outlet disposed at the same elevation. The plurality of gas separation membranes may comprise between six and eighteen gas separation membranes.

The portable skid arrangement may further comprise: the supply line selectively coupled to the frame; the flare line selectively coupled to the frame; and the outlet line selectively coupled to the frame. Each of the supply line, the flare line, and the outlet line may be positioned outside of the frame. Each of the supply line, the flare line, and the outlet line may be positioned within the frame. A first number of the plurality of gas separation membranes may be disposed on a first side of each of the supply line, the flare line, and the outlet line, and a second number of the plurality of gas separation membranes may be disposed on a second side, opposite the first side, of each of the supply line, the flare line, and the outlet line.

The frame may be structured to receive forks of a forklift for moving the portable skid arrangement. The frame may further comprise a number of elements structured to be engaged by forks of a forklift.

As another aspect of the disclosed concept, a system for processing renewable natural gas is provided. The system comprises: a supply line structured to convey a flow of unprocessed gas; a flare line structured to convey gas to a flare arrangement; an outlet line structured to convey filtered gas from the system; and a number of portable skid arrangements as previously discussed. The number of portable skid arrangements may comprise a plurality of portable skid arrangements.

These and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are provided for the purpose of illustration and description only and are not intended as a definition of the limits of the disclosed concept.

### BRIEF DESCRIPTION OF THE DRAWINGS

A full understanding of the disclosed concept can be gained from the following description of the preferred embodiments when read in conjunction with the accompanying drawings in which:

FIG. 1 is a perspective view of a gas processing skid in accordance with an example embodiment of the disclosed concept shown coupled to examples portions of related system piping;

FIG. 2 is another perspective view of the gas processing skid of FIG. 1;

FIG. 3 is yet another perspective view of the gas processing skid of FIG. 1;

FIG. 4 is a perspective view of a gas processing skid in accordance with another example embodiment of the disclosed concept;

FIG. 5 is another perspective view of the gas processing skid of FIG. 4;

FIG. 6 is a perspective view of a gas processing skid in accordance with yet another example embodiment of the disclosed concept;

FIG. 7 is another perspective view of the gas processing skid of FIG. 6; and

FIG. 8 is a perspective view of a system for processing gas in accordance with an example embodiment of the disclosed concept including a gas processing skid such as shown in FIGS. 1-3 and another gas processing skid such as shown in FIGS. 6 and 7.

### DETAILED DESCRIPTION

It is to be appreciated that the specific elements and embodiments illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As employed herein, the term “number” shall mean one or an integer greater than one (i.e., a plurality).

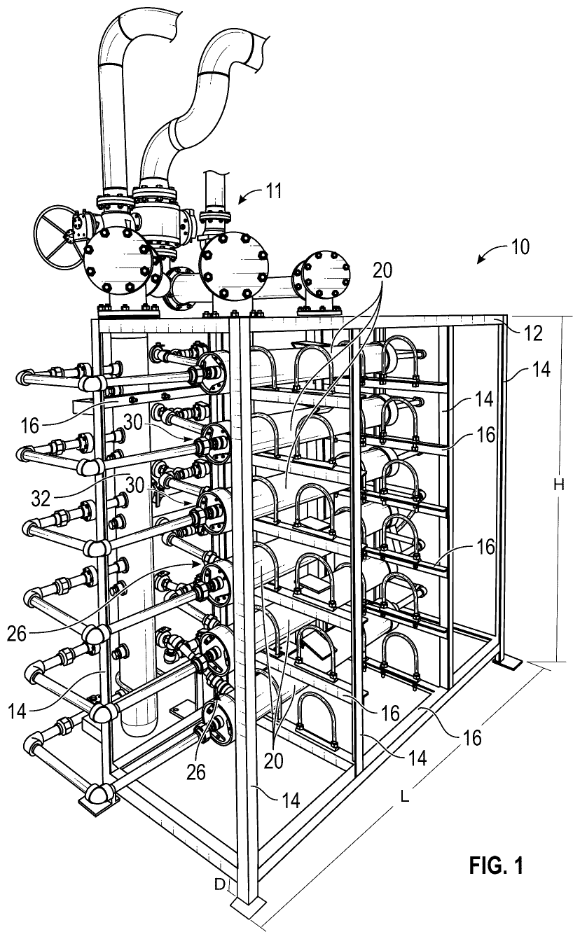

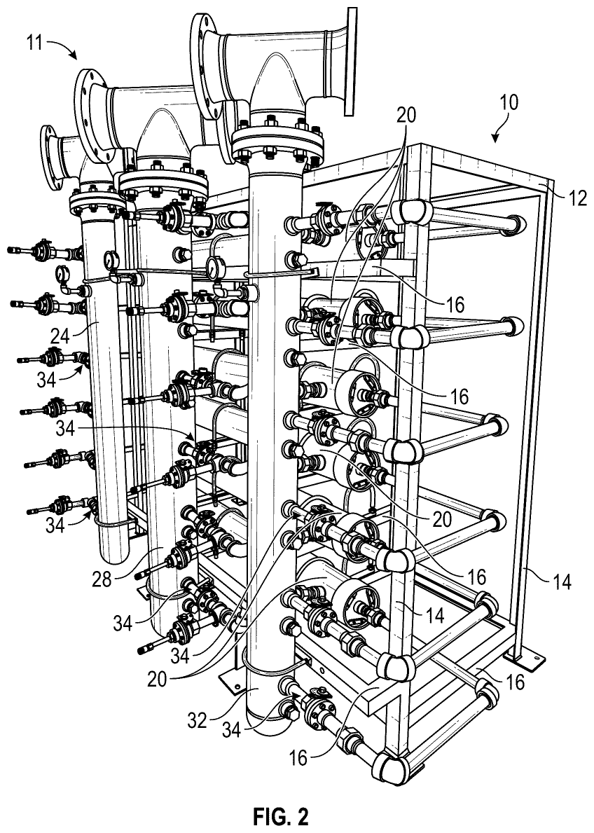

Embodiments of the disclosed concept improve upon conventional arrangements by providing readily portable, adaptable arrangements for use in processing RNG. An example embodiment of such an arrangement in accordance with the disclosed concept is shown in FIGS. 1-3 in the form of a readily portable skid arrangement 10 (shown coupled with non-limiting examples of related system piping, shown generally at 11) that is sized and configured to be readily moveable via a forklift or other similar, readily available device. The skid arrangement 10 includes a rigid frame 12, having vertical members 14 and horizontal members 16 (only some of each are numbered) which are fixedly coupled together to form the frame 12. In the example embodiment illustrated in FIGS. 1-3, the frame is formed from a combination of welded angle iron members, however, it is to be appreciated that other elements/materials/fastening arrangement(s) may be employed without varying from the scope of the disclosed concept.

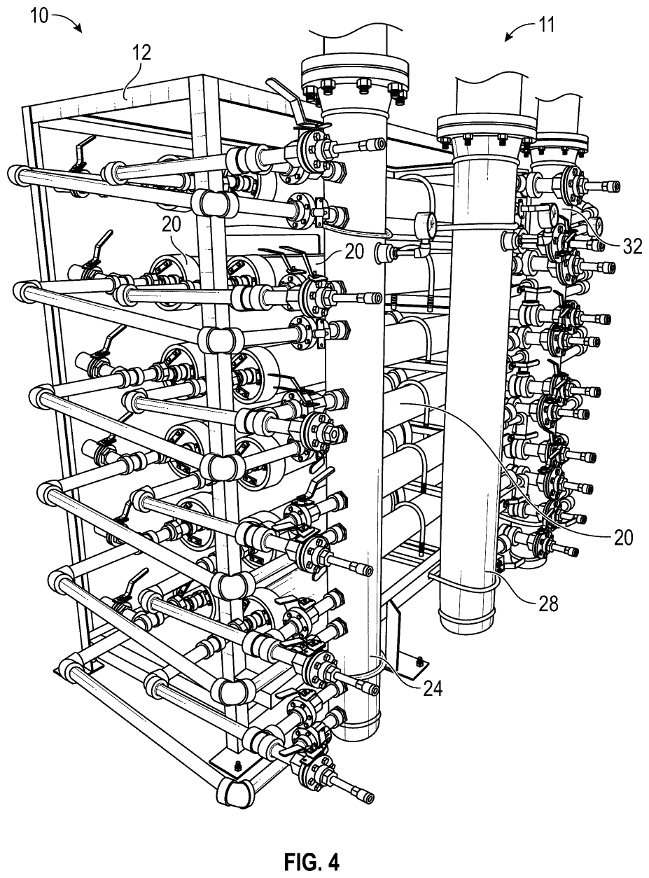

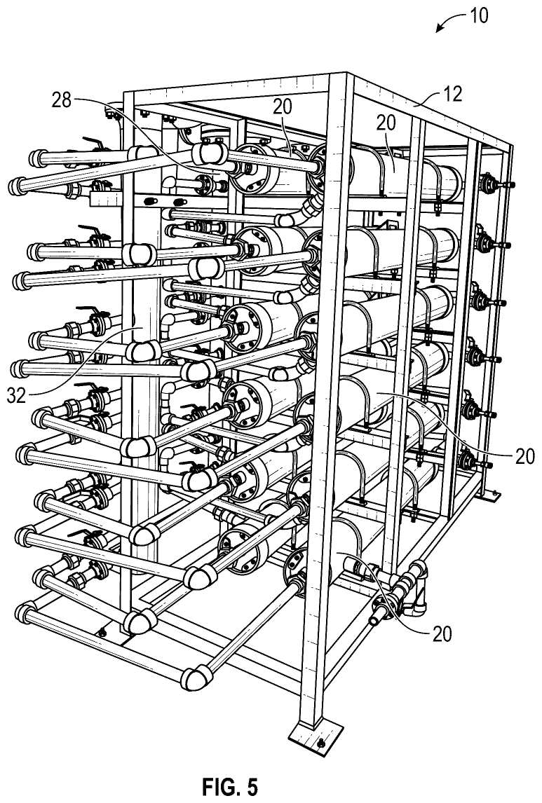

The skid arrangement 10 further includes a plurality of gas separation membranes 20 (e.g., without limitation, such as separation membranes produced by Evonik—https://www. membrane-separation.com/en/upgrading-of-biogas-to-biomethane-with-sepuran-green or other suitable component) selectively coupled to/within the frame 12 via any suitable arrangement. In the example skid arrangement 10 shown in FIGS. 1-3, six separation membranes 20 are shown coupled to the frame 12, however, it is to be appreciated that the quantity of membranes 20 may be varied without varying from the scope of the disclosed concept. For example, FIGS. 4 and 5 show another example skid arrangement 12 similar to that of FIGS. 1-3 but including twelve separation membranes 20. Other examples including as many as eighteen separation membranes 20 have also been employed while still maintaining the advantageous portability of the disclosed concept.

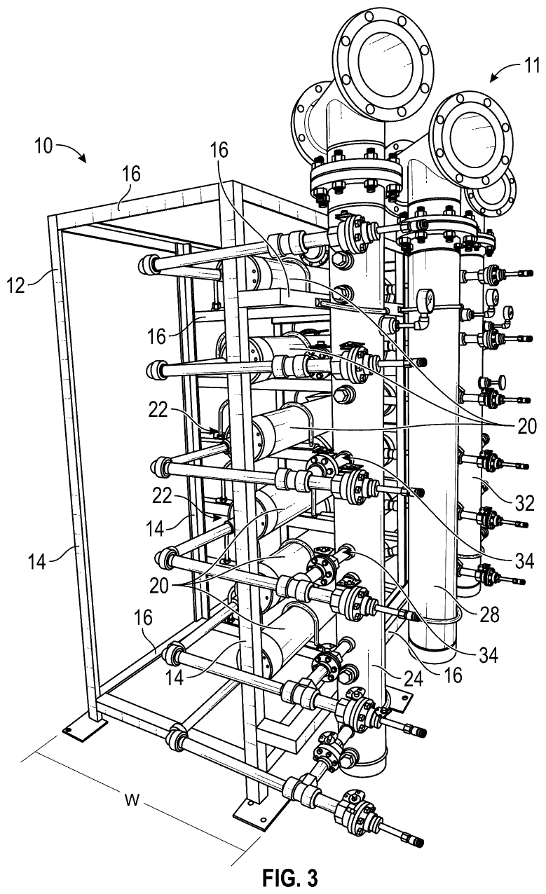

Continuing to refer to FIGS. 1-3, each gas separation membrane 20 includes: an inlet 22 (FIG. 3) in communication with (e.g., via suitable rigid or flexible piping, not numbered), and structured to receive unprocessed gas from, a supply line 24; a flare outlet 26 (FIG. 1) in communication with, and structured to evacuate communicate filtered gas separated from the unprocessed gas by the separation membrane 20 to, a flare line 28; and a primary outlet 30 (FIG. 1) in communication with, and structured to communicate remaining gas after the filtered gas has been separated from the unprocessed gas to an outlet line 32. Each gas separation membrane is selectively isolatable from each of the supply, flare, and outlet lines 24, 28, 32 by respective valves 34 (only some of which are numbered) positioned between the gas separation membrane 20 and each of the supply, flare, and outlet lines 24, 28, 32. Such arrangement allows for particular membranes 20 to be selectively taken out of service for maintenance/replacement and/or for times when less than the full quantity of membranes are needed. In the example embodiment illustrated in FIGS. 1-3, each separation membrane 20 is mounted to the frame 12 so as to be disposed generally horizontally with the inlet 22 and the primary outlet 30 disposed at the same elevation. While such arrangement has been found to be beneficial for general access, maintenance and replacement purposes, it is to be appreciated that one or more of the separation membranes 20 may be disposed in other orientations without varying from the scope of the disclosed concept.

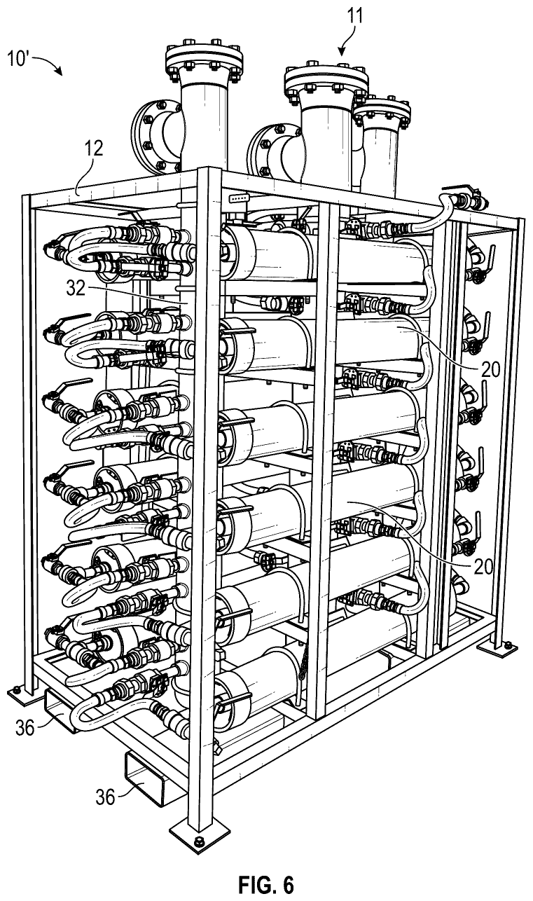

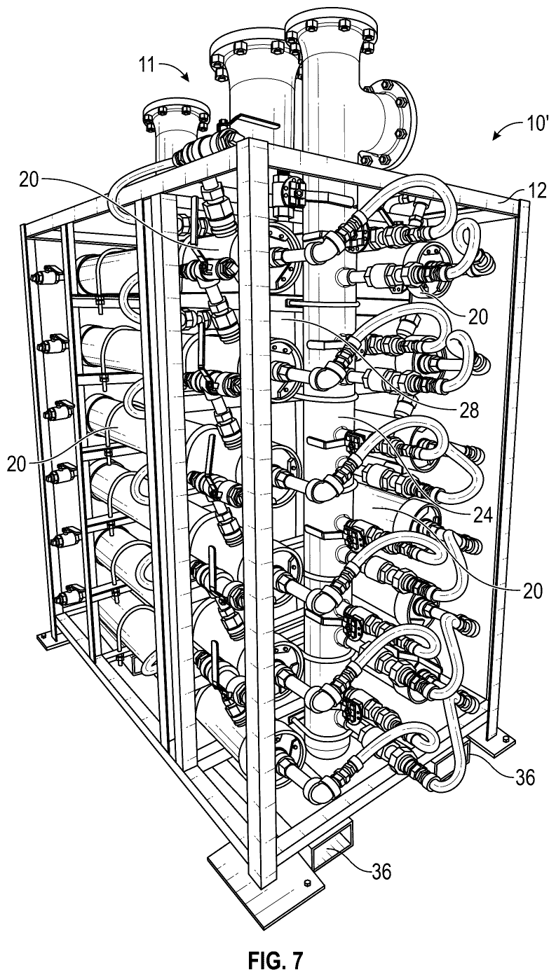

Each of the supply line 24, the flare line 28, and the outlet line 32 may be selectively coupled to the frame 12 so as to be elements of the skid arrangement 10, or uncoupled from the frame 12 such that the skid arrangement 10 may be transported without such items. As shown in the example embodiments of FIGS. 1-3 and that of FIGS. 4 and 5, one or more of the supply line 24 the flare line 28, and the outlet line 32 may be positioned outside of the frame 12. As shown in the example skid arrangement 10′ of FIGS. 6 and 7, the supply line 24, the flare line 28, and the outlet line 32 may be positioned generally inside of the frame 12. In the example arrangement 10′ of FIGS. 6 and 7, the gas separation membranes 20 are positioned on opposite sides of the supply line 24, the flare line 28, and the outlet line 32, however, it is to be appreciated that the supply line 24, the flare line 28, and the outlet line 32 may be disposed within the frame 12 with all of the membranes 20 on the same side without varying from the scope of the disclosed concept. In example embodiments of the disclosed concept, the frame 12 is structured to receive forks of a forklift for moving the portable skid arrangement 10. Such structure may be provided by providing a suitable spacing D (FIG. 1, e.g., without limitation, approximately three inches) at the bottom of the frame 12 such that forks of a forklift can be readily received generally under the frame 12 and thus the skid arrangement 10 such that the arrangement 10 can be readily lifted and moved by a forklift. As shown in the example skid arrangement 10 of FIGS. 6 and 7, the frame 12 may include a number of elements, e.g., fork tubes 36, that are structured to receive the forks of a forklift for assisting in safely moving the skid arrangement 10.

In order to ensure portability via readily available means (e.g., forklift, standard dual-axle trailer, etc.) the size and weight of the skid arrangements 10 in accordance with the disclosed concept are limited as compared to conventional arrangements. For example, in some example embodiments of the disclosed concept the frame 12 has a height H (FIG. 1) that is equal to or greater than the greater of a width W (FIG. 3) or a length L (FIG. 1) of the frame 12. In some example embodiments the frame 12 has a length L of ten feet or less and a width W of six feet or less. In some example embodiments the frame 12 has a length L of at least six feet. In some example embodiments the frame 12 has a width W of at least four feet. In some example embodiments the frame 12 has a height H of twelve feet or less. In some example embodiments the frame 12 has a height H of at least eight feet. In some example embodiments the portable skid arrangement 10 has a total weight of less than 12,000 pounds. In some example embodiments the portable skid arrangement 10 has a total weight of less than 6,000 pounds.

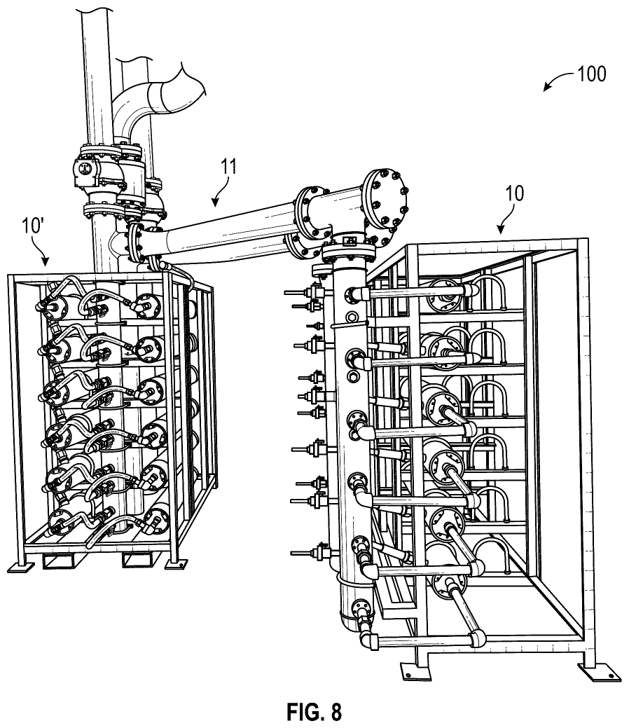

As shown in the example embodiment of FIG. 8, multiple skid arrangements 10, 10′ may be employed as elements of a system 100 for processing renewable natural gas. In such arrangement, skid arrangements 10, 10′ may be readily added or removed from the system 100 as needed for processing RNG. One or more skid arrangement 10, 10′ may also be employed to supplement other processing arrangements when additional and/or alternative processing capacity is needed.

In view of the foregoing discussion and example embodiments it is thus to be appreciated that embodiments of the disclosed concept are designed to provide readily transportable and expandable solutions for processing RNG. Embodiments of the disclosed concept alleviate extended downtimes, upgrade added SCFM of gas, increase methane recovery, and alleviate potential lead times from vendor(s). Embodiments of the disclosed concept can be expanded to handle an unlimited amount of SCFM (e.g., using multiple skids if needed to maintain desired mobility). The addition of one or more further separation stage(s), e.g., on a single skid 10, 10′ or via additional skids 10, 10′ can also be readily added as desired for enhanced methane recovery depending on the needs for a particular recovery/processing site.

While specific embodiments of the disclosed concept have been described in detail, it will be appreciated by those skilled in the art that various modifications and alternatives to those details could be developed in light of the overall teachings of the disclosure. Accordingly, the particular arrangements disclosed herein are meant to be illustrative only and not limiting as to the scope of disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In any device claim enumerating several means, several of these means may be embodied by one and the same item of hardware. The word “a” or “an” preceding an element does not exclude the presence of a plurality of such elements. The mere fact that certain elements are recited in mutually different dependent claims does not indicate that these elements cannot be used in combination.

What is claimed is:

1. A portable skid arrangement for processing renewable natural gas, the skid arrangement comprising:
a frame;
a plurality of gas separation membranes selectively coupled to the frame, each gas separation membrane including:
an inlet structured to be in communication with, and to receive unprocessed gas from, a supply line;
a flare outlet structured to be in communication with, and to disperse unwanted filtered gas separated from the unprocessed gas to a flare line; and
a primary outlet structured to be in communication with, and to disperse remaining gas after the filtered gas has been separated from the unprocessed gas to an outlet line.

2. The portable skid arrangement wherein the frame has a height that is equal to or greater than the greater of a width or a length of the frame.

3. The portable skid arrangement of claim 1, wherein the frame has a length of ten feet or less and a width of six feet or less.

4. The portable skid arrangement of claim 3, wherein the frame has a length of at least six feet.

5. The portable skid arrangement of claim 3, wherein the frame has a width of at least four feet.

6. The portable skid arrangement of claim 3, wherein the frame has a height of twelve feet or less.

7. The portable skid arrangement of claim 6, wherein the frame has a height of at least eight feet.

8. The portable skid arrangement of claim 1, wherein the arrangement has a total weight of less than 12,000 pounds.

9. The portable skid arrangement of claim 1, wherein the arrangement has a total weight of less than 6,000 pounds.

10. The portable skid arrangement of claim 1, wherein each gas separation membrane is disposed horizontally with the inlet and the primary outlet disposed at the same elevation.

11. The portable skid arrangement of claim 1, wherein the plurality of gas separation membranes comprises between six and eighteen gas separation membranes.

12. The portable skid arrangement of claim 1, further comprising:
the supply line selectively coupled to the frame;
the flare line selectively coupled to the frame; and
the outlet line selectively coupled to the frame.

13. The portable skid arrangement of claim 12, wherein each of the supply line, the flare line, and the outlet line are positioned outside of the frame.

14. The portable skid arrangement of claim 12, wherein each of the supply line, the flare line, and the outlet line are positioned within the frame.

15. The portable skid arrangement of claim 14, wherein a first number of the plurality of gas separation membranes are disposed on a first side of each of the supply line, the flare line, and the outlet line, and
wherein a second number of the plurality of gas separation membranes are disposed on a second side, opposite the first side, of each of the supply line, the flare line, and the outlet line.

16. The portable skid arrangement of claim 1, wherein the frame is structured to receive forks of a forklift for moving the portable skid arrangement.

17. The portable skid arrangement of claim 16, wherein the frame further comprises a number of elements structured to be engaged by forks of a forklift.

18. A system for processing renewable natural gas comprising:
a supply line structured to convey a flow of unprocessed gas;
a flare line structured to convey gas to a flare arrangement;
an outlet line structured to convey filtered gas from the system; and
a number of portable skid arrangements, each skid arrangement comprising:
a frame;
a plurality of gas separation membranes selectively coupled to the frame, each gas separation membrane including:
an inlet in communication with, and structured to receive unprocessed gas from, the supply line;
a flare outlet in communication with, and structured to disperse unwanted filtered gas separated from the unprocessed gas to the flare line; and
a primary outlet in communication with, and structured to disperse remaining gas after the filtered gas has been separated from the unprocessed gas to the outlet line.

19. The system of claim 18, wherein the number of portable skid arrangements comprises a plurality of portable skid arrangements.
